(19) United States
(12) Patent Application Publication
(10) Pub. No.: US 2022/0024615 A1
(43) Pub. Date: Jan. 27, 2022

(54) KITCHEN DEVICE THAT FILLS FOOD POUCHES IN AN AUTOMATED FASHION

(71) Applicant: Mark Sebik, Glen Gardner, NJ (US)

(72) Inventor: Mark Sebik, Glen Gardner, NJ (US)

(21) Appl. No.: 17/373,074

(22) Filed: Jul. 12, 2021

Related U.S. Application Data
(60) Provisional application No. 63/056,803, filed on Jul. 27, 2020.

(51) Int. Cl. B65B 1/12; B65B 39/00

(52) U.S. Cl. CPC B65B 1/12; B65B 3/12; B65B 39/00

(57) ABSTRACT

A food processing apparatus used in household kitchens provides the ability to fill pouches or personal containers with food automatically. The apparatus may include a food source container, a motor, and a mechanical displacement pump. The source container typically rests on top of the pump; which is driven by a motor connected to a power source. Food is placed in the source container, which has an opening on the bottom side to allow the food to pass into the pump. The pump moves the food through a discharge port on one side. A single food pouch, or many pouches using optional connectors, is connected to the discharge port of the pump. The apparatus may be used to fill containers with soft foods like yogurt. Typically, harder textured foods like sweet potatoes need to be softened. In at least one embodiment, the need to manually press food, is eliminated.

### CROSS REFERENCE TO RELATED APPLICATION(S)

The present application claims the priority of provisional patent application Ser. No. 63/056,803 filed on Jul. 27, 2020, inventor and applicant Mark Sebik.

### FIELD OF THE INVENTION

This invention relates to kitchen devices.

### BACKGROUND OF THE INVENTION

Currently, there are a number of solutions for filling food pouches at home. Some of these solutions attempt to use manual labor. Some of these use a stick plunger to manually force the food into a pouch, but these solutions fail to meet the needs of the industry because not only are these methods physically exhausting but they create a huge mess and can take hours to complete when preparing meals for the week. Other solutions attempt to fill pouches using a spoon, scoop by scoop, but these solutions are similarly unable to meet the needs of the industry because they are also too slow and time consuming.

### SUMMARY OF THE INVENTION

One or more embodiments of the present invention provide an automatic food pouch filling apparatus that saves an enormous amount of time and physical energy. Furthermore, the apparatus, in at least one embodiment, creates less mess and is easily cleaned using a dishwasher. Still, further, the apparatus fills multiple food pouches at once, accommodating larger families and weekly meal preparations. In at least one embodiment of the present invention, the disclosed apparatus advantageously fills these needs and addresses the aforementioned deficiencies by providing a mechanical pump that discharges food into food pouches without physical labor.

Disclosed is a food pouch filling apparatus, which is made up of the following components: (a) a container which is connected to the pump on its bottom side, the container has an opening on the bottom to allow the passage of food; (b) a mechanical displacement pump, which may be but not limited to a screw pump or a progressive cavity pump, which is connected to a motor on one side and also connected to the food container on its top-side; this pump also has a discharge opening or port on one side; (c) a motor is connected to the pump and a power cord; and (d) a power cord which is connected to the motor and a power source.

The apparatus, in one or more embodiments of the present invention, may also have one or more of the following: (1) a connector mechanism for allowing multiple pouches to be filled by extension, wherein this mechanism is configured to connect to the discharge port of the pump; and (2) a food processor accessory that is configured to sit on top of or inside the food container providing pre-processing tasks, like mixing, blending, etc., of food contents before moving into the pump.

The disclosed apparatus, in at least one or more embodiments, is unique when compared with other known devices and solutions because it provides an automated, faster and cleaner solution of filling food pouches at home.

The disclosed apparatus, in at least one or more embodiments, is unique in that it is structurally different from other known devices or solutions. More specifically, the device is unique due to the presence of (i) a mechanical pump that moves food in an automated fashion into a food pouch; and (ii) a motor that drives the pump.

In one or more embodiments an apparatus is provided comprising: a container having a bottom opening; a housing having an inner chamber and a discharge port; and a pump located within the inner chamber of the housing; and wherein the container is configured to be connected to the housing to allow food to be placed into the container and to fall through the bottom opening of the container into the inner chamber of the housing, and to be moved by the pump towards and out the discharge port of the housing.

In at least one embodiment the apparatus further includes a first pouch having an input port and configured to be connected to the discharge port of the housing, so that the first pouch is configured to collect food pumped out from the inner chamber of the housing through the discharge port and into an inner chamber of the pouch.

The apparatus may include a connector mechanism having an input port which is configured to be connected to the discharge port of the housing and having a plurality of output ports. The pump may be screw type pump.

In at least one embodiment, a plurality of pouches are provided, each having an input port and configured to be connected to one of the plurality of output ports of the connector mechanism, so that the input ports of the plurality of pouches are configured to be simultaneously connected to the connector mechanism, one input port for one pouch of the plurality of pouches for each output port of the connector mechanism.

In at least one embodiment, a method is provided which includes placing food into a container, which is connected to a housing; and discharging the food out a discharge port of the housing. The container may have a bottom opening; wherein the housing has an inner chamber and the discharge port; wherein there is a pump located within the inner chamber of the housing; and wherein the container is configured to be connected to the housing to allow food to be placed into the container and to fall through the bottom opening of the container into the inner chamber of the housing, and to be moved by the pump towards and out the discharge port of the housing.

The method may include attaching an input port of the first pouch to a discharge port of the housing, so that food discharged out the discharge port is discharged into the first pouch through the input port of the first pouch.

The method may include connecting an input port of a connector mechanism to the discharge port of the housing, so that food discharged out the discharge port is discharged into an inner chamber of the connector mechanism through the input port of the connector mechanism.

The method may include simultaneously connecting a plurality of pouches to a plurality of corresponding output ports of the connector mechanism so that food discharged into the inner chamber of the connector mechanism through the input port of the connector mechanism is split up into a plurality of branches corresponding to the plurality of pouches.

This disclosure will now provide a more detailed and specific description that will refer to the accompanying drawings. The drawings and specific descriptions of the drawings, as well as any specific or alternative embodiments discussed, are intended to be read in conjunction with the entirety of this disclosure. The kitchen apparatus that fills food pouches in an automated fashion may, however, be embodied in many different forms and should not be construed as being limited to the embodiments set forth herein; rather, these embodiments are provided by way of illustration only and so that this disclosure will be thorough, complete and fully convey understanding to those skilled in the art.

### BRIEF DESCRIPTION OF THE DRAWINGS

FIG. 1 shows a side view of the food pouch filling apparatus;

FIG. 2 shows a top view perspective of the food pouch filling apparatus;

FIG. 3 shows the food pouch filling device with the container detached;

FIG. 4A shows a perspective view of the pouch filling apparatus, and a pouch for connecting to a port of the pouch filling apparatus;

FIG. 4B shows a closeup view of part of FIG. 4A; and

FIG. 5 shows a cross section view of the pouch filing apparatus, so that at least part of a mechanical pump and a motor within a housing, can be seen.

FIG. 6 shows a perspective view of a connector mechanism including an input tube portion having an opening leading into an inner chamber of a body portion, and a plurality of branches or output tubes;

FIG. 7 shows the input tube portion of the connector mechanism in the process of being connected to a port of the pouch filling apparatus; and a plurality of pouches or containers; and

FIG. 8 shows a top view of the connector mechanism, a top view of one pouch, and side views of two other pouches.

### DETAILED DESCRIPTION OF THE DRAWINGS

One or more embodiments of the present invention are directed to a kitchen apparatus that fills food pouches in an automated fashion.

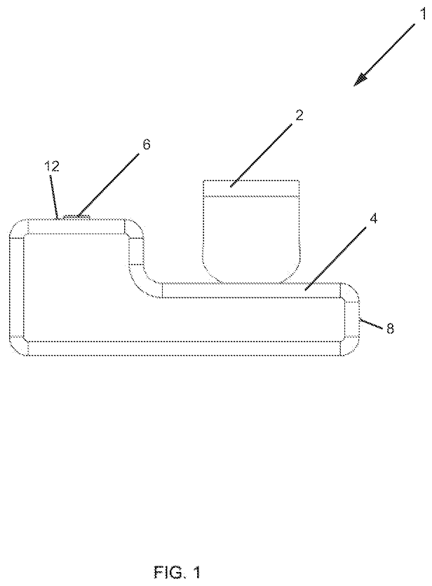

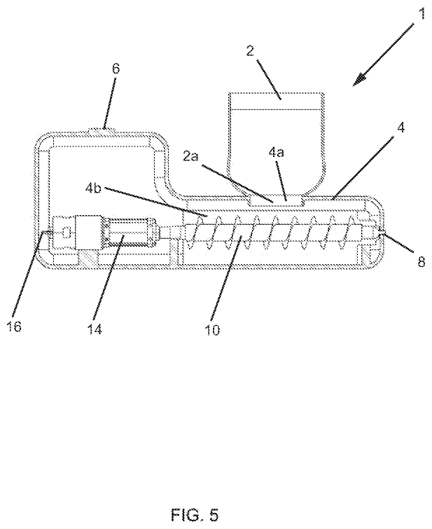

Referring to FIGS. 1-5, in its most complete version, the kitchen apparatus 1 is made up a container or bowl 2 that is connected near the top-side of a pump 10, with the bottom bowl 2 having an opening 2a, shown in FIG. 5, sufficient for passing food through and into the pump housing 4 an onto shaft or pump 10. The kitchen apparatus 1 also includes the mechanical pump or shaft 10 that receives food from the container 2 and is configured to move the food to a discharge port 8. The kitchen apparatus 1 also includes a motor 14 that is connected to the pump or shaft 10, wherein the motor is configured to rotated the pump or shaft 10. The kitchen apparatus 1 may also include a power cord 16 that connects to the motor 14 to a power source, not shown, such as through a plug, and an outlet. The motor 14 may, alternatively be powered by a battery.

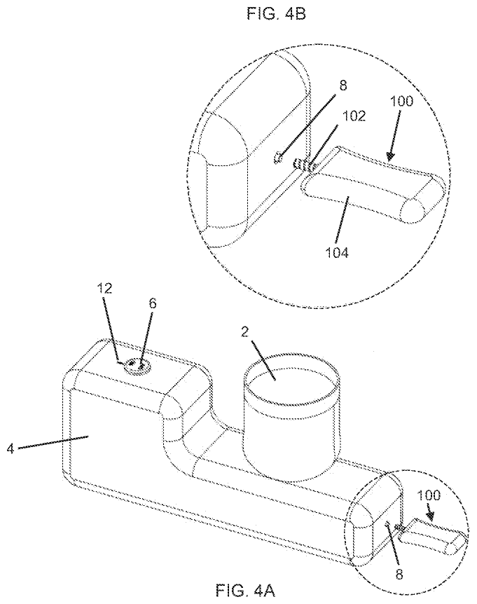

The kitchen apparatus 1 may also include a food pouch or personal container 100 shown in FIGS. 4A-4B, or the kitchen apparatus 1 may be described as being separate from the container or pouch 100.

In at least one embodiment, the pouch or container 100 has a tube 102 which is configured to connect to the discharge port 8 of the pump or shaft 10, and the container 100 or the body 104 of the container 100 receives the contents being discharged from an inner chamber 4b of the housing 4.

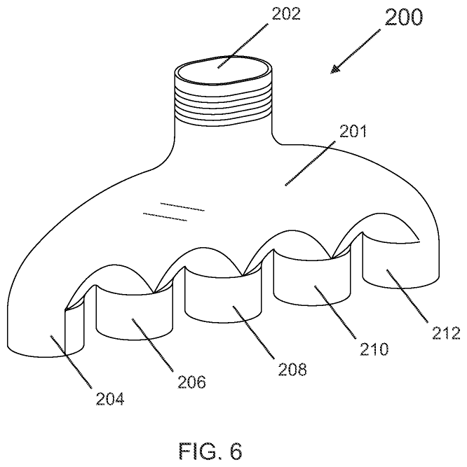

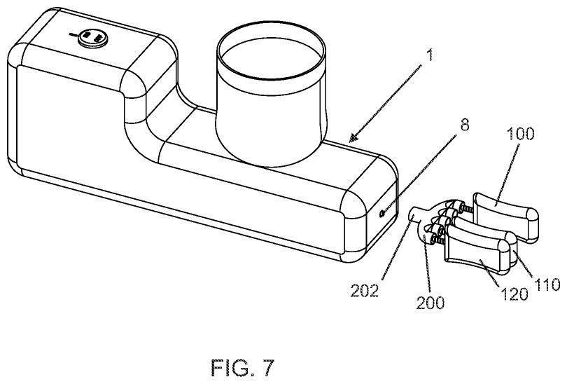

As shown in FIGS. 6-8, In at least one embodiment, a connector mechanism 200 that connects multiple pouches or containers, such as containers or pouches 100, 110, and 120 shown in FIG. 7, on one side of the apparatus 1 and is connected to the discharge port 8 of the pump or shaft 10 on its other side may be provided.

FIG. 6 shows a perspective view of a connection mechanism 200 including an input tube portion 202 having an opening leading into an inner chamber of a body or root portion 201, and a plurality of branches or output tubes 204, 206, 208, 210, and 212.

FIG. 7 shows the input tube portion 202 of the connection mechanism 200 in the process of being connected to the port 8 of the apparatus 1; and each of the pouches or containers 100, 110, and 120 in the process of being connected to one of the output tubes 204, 206, 208, 210, and 212. Each of the pouches 100, 110, and 120 may be identical, including identical in structure to the pouch 100 shown in FIG. 4B. Each of the pouches 100, 110, and 120 may have an inner chamber, and an outer housing or wall, similar or identical to outer housing or wall 104, and a tube similar or identical to tube 102, leading to a completely sealed inner chamber within housing or wall 104, except for an opening in tube 102 leading to the inner chamber.

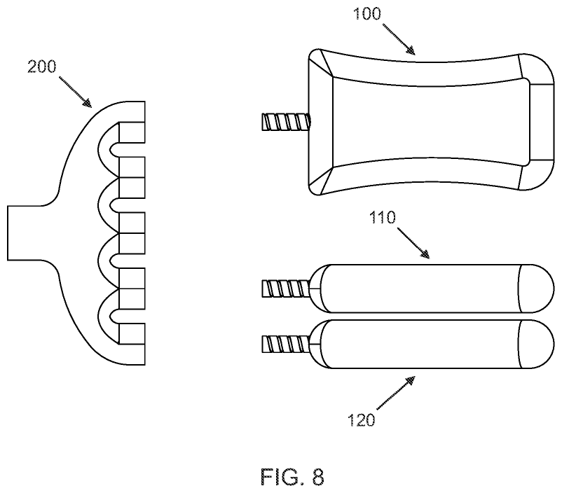

FIG. 8 shows a top view of the connection mechanism 200, a top view of the pouch 100, and side views of the pouches 110 and 120.

FIG. 1 shows an outer side view of the food pouch filling apparatus 1 with the container 2 attached. The apparatus 1 shows a power control switch 6 on an LED (light emitting diode) 12 side on the top and a discharge port 8 located on the far right side. This view shows the apparatus 1 with an enclosure that encapsulates the mechanical parts hidden in this view which includes the mechanical pump 10 and the motor 12.

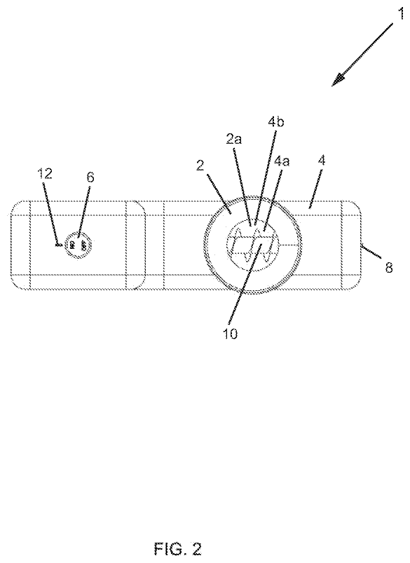

FIG. 2 illustrates a top view of the food pouch filling apparatus 1 with the container 2 attached. This view demonstrates how the food flows through the top opening 4a in the housing 4, and into the inner chamber 4b of on top of or near the mechanical pump or shaft 10 from the container 2. Near the center is a round container 2 with an opening 2a on its bottom-side allowing the mechanical pump or shaft 10 to be visible from this top view. On the far right, the discharge port 8 can be seen where a pouch 100, not shown, can be connected.

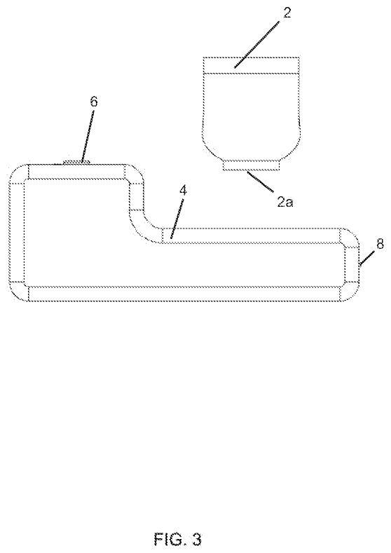

FIG. 3 shows a food pouch filling apparatus 1 with the container 2 detached.

FIG. 4A illustrates the food pouch filling apparatus 1 and a pouch 100, with the pouch 100 in the process of being connected to the discharge port 8 of the apparatus 1. Similarly, an adapter, not shown, can be connected to the discharge port 8 and more than one pouch can be connected to such an adapter, not shown.

FIG. 4B shows a closeup of the pouch in the process of being connected by connecting tube 102 to the port 8 of the apparatus 1.

FIG. 5 illustrates how the internal mechanics of the food pouch filling apparatus 1 may be constructed. A motor 14 located on the left hand side is connected to a mechanical pump or shaft 10, a screw pump in this drawing, which moves the contents, received from the container 2, to the discharge port 8 located on the right hand side.

Different features, variations and multiple different embodiments have been shown and described with various details. What has been described in this application at times in terms of specific embodiments is done for illustrative purposes only and without the intent to limit or suggest that what has been conceived is only one particular embodiment or specific embodiments. It is to be understood that this disclosure is not limited to any single specific embodiments or enumerated variations.

Many modifications, variations and other embodiments will come to mind of those skilled in the art, and which are intended to be and are in fact covered by this disclosure. It is indeed intended that the scope of this disclosure should be determined by a proper legal interpretation and construction of the disclosure, including equivalents, as understood by those of skill in the art relying upon the complete disclosure present at the time of filing.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. An apparatus comprising:
a container having a bottom opening;
a housing having an inner chamber and a discharge port;
a pump located within the inner chamber of the housing;
and wherein the container is configured to be connected to the housing to allow food to be placed into the container and to fall through the bottom opening of the container into the inner chamber of the housing, and to be moved by the pump towards and out the discharge port of the housing.

2. The apparatus of claim 1 further comprising
a first pouch having an input port and configured to be connected to the discharge port of the housing, so that the first pouch is configured to collect food pumped out from the inner chamber of the housing through the discharge port and into an inner chamber of the pouch.

3. The apparatus of claim 1 further comprising
a connector mechanism having an input port which is configured to be connected to the discharge port of the housing and having a plurality of output ports.

4. The apparatus of claim 1 wherein
the pump is a screw type pump.

5. The apparatus of claim 3 further comprising
a plurality of pouches each having an input port and configured to be connected to one of the plurality of output ports of the connector mechanism, so that the input ports of the plurality of pouches are configured to be simultaneously connected to the connector mechanism, one input port for one pouch of the plurality of pouches for each output port of the connector mechanism.

6. A method comprising:
placing food into a container, which is connected to a housing; and
discharging the food out a discharge port of the housing;
wherein the container has a bottom opening;
wherein the housing has an inner chamber and the discharge port;
wherein there is a pump located within the inner chamber of the housing;
and wherein the container is configured to be connected to the housing to allow food to be placed into the container and to fall through the bottom opening of the container into the inner chamber of the housing, and to be moved by the pump towards and out the discharge port of the housing.

7. The method of claim 6 further comprising
attaching an input port of the first pouch to a discharge port of the housing, so that food discharged out the discharge port is discharged into the first pouch through the input port of the first pouch.

8. The method of claim 6 further comprising
connecting an input port of a connector mechanism to the discharge port of the housing, so that food discharged out the discharge port is discharged into an inner chamber of the connector mechanism through the input port of the connector mechanism.

9. The method of claim 8 further comprising
simultaneously connecting a plurality of pouches to a plurality of corresponding output ports of the connector mechanism so that food discharged into the inner chamber of the connector mechanism through the input port of the connector mechanism is split up into a plurality of branches corresponding to the plurality of pouches.

10. The method of claim 6 wherein
the pump is a screw type pump.
